(19) United States
(12) Patent Application Publication
(10) Pub. No.: US 2007/0225435 A1
(43) Pub. Date: Sep. 27, 2007

(54) Intrinsically viscous, aqueous dispersions, method for the production thereof, and use thereof, and uses thereof

(75) Inventors: Ulrike Rockrath, Senden (DE); Joachim Woltering, Munster (DE); Gunther Ott, Munster (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AG, Munster (DE)

(21) Appl. No.: 10/595,616

(22) PCT Filed: Oct. 8, 2004
(86) PCT No.: PCT/EP04/52919

§ 371 Date: Nov. 1, 2006

(30) Foreign Application Priority Data
Nov. 17, 2003 (DE) 10353638.8

(51) Int. Cl. C08G 18/08

(52) U.S. Cl. 524/839

(57) ABSTRACT

Disclosed herein are pseudoplastic aqueous dispersions having solid and/or high-viscosity particles (A), dimensionally stable under storage and application conditions, in dispersion in a continuous aqueous phase (B), the dispersion having at least one solid polyurethanepolyol (C) containing cycloaliphatic structural units having a glass transition temperature >15 ° C., processes for preparing them, and their use.

The present invention relates to new pseudoplastic aqueous dispersions. The present invention also relates to a new process for preparing pseudoplastic aqueous dispersions. The present invention additionally relates to the use of the new pseudoplastic aqueous dispersions and of the pseudoplastic aqueous dispersions prepared using the new process as coating materials, adhesives, and sealants for coating, adhesively bonding, and sealing bodies of means of transport and parts thereof, buildings and parts thereof, doors, windows, furniture, small industrial parts, mechanical, optical, and electronic components, coils, containers, packaging, hollow glassware, and articles of everyday use.

Pseudoplastic aqueous dispersions comprising solid and/or high-viscosity particles (A), dimensionally stable under storage and application conditions, in a continuous aqueous phase (B) are known from, for example, German patent application DE 100 27 292 A 1 and DE 101 35 997 A 1 (cf. in particular DE 100 27 292 A 1, page 2, para. [0013] to page 3, para. [0019], and DE 101 35 997, page 4, paras. [00341 to [0041]). The pseudoplastic aqueous dispersions are also referred to as powder slurries. They can be used outstandingly as coating materials, adhesives and sealants, in particular as coating materials, more specifically as powder slurry clearcoat materials. Like liquid coating materials they can be applied by spray application. The drying and curing behavior of the resultant films, on the other hand, is like that of powder coating films; in other words, filming and curing take place in two discrete stages. Not least, as with the powder coating materials, application, filming, and curing are all unaccompanied by release of volatile organic solvents. In short the powder slurries combine key advantages of liquid coating materials and powder coating materials, so making them especially advantageous. Depending on the glass transition temperature of their dimensionally stable particles (B) the powder slurries may undergo initial drying either as powder or as film.

For example, the use of UV-stable, blocked aliphatic polyisocyanates as crosslinking agents (cf. for example German patent application DE 101 35 997 A 1) lowers the glass transition temperature of the dimensionally stable particles (B). In some instances, therefore, the powder slurries in question may undergo initial drying no longer as a powder but instead partly as a film. As a consequence of this the popping limit in the applied films may drop below a level tolerated by the customer, since water vapor bubbles may become enclosed in the film even at comparatively low film thicknesses. On curing, in particular on thermal curing, the enclosed water in such cases is given off too late and then leads to pops and other surface defects. The clearcoats produced from these powder slurries do, however, have a high stability toward blushing, i.e., the whitening of the clearcoats following moisture exposure.

In order to avoid the problem of filming during initial drying it is possible to replace the blocked aliphatic polyisocyanates by blocked cycloaliphatic polyisocyanates which raise the glass transition temperature of the dimensionally stable particles (cf. German patent application DE 198 41 842 A 1). The powder slurries in question then generally dry as powder, so that the formation of pops is avoided when the applied films in question are cured. However, the resultant clearcoats in some instances blush following moisture exposure.

Both problems can be avoided by using blocked aliphatic and cycloaliphatic polyisocyanates in a balanced proportion (cf. German patent application DE 100 40 223 A 1). The chemical resistance of the clearcoats produced from the corresponding powder slurries, however, can only be raised by increasing the proportion of blocked cycloaliphatic polyisocyanate relative to blocked aliphatic polyisocyanate. In that case, however, there is again a more frequent occurrence of blushing in the clearcoats produced from the corresponding powder slurries.

It is an object of the present invention to provide new pseudoplastic aqueous dispersions which comprise solid and/or high-viscosity particles (A), dimensionally stable under storage and application conditions, in a continuous aqueous phase (B), i.e., powder slurries, especially powder slurry clearcoat materials, which no longer have the disadvantages of the prior art but which instead, after application, initial drying, and curing, in particular thermal curing, produce coatings, adhesive layers, and seals, especially coatings, more particular clearcoats, which are free from surface defects, in particular from pops, no longer exhibit any blushing after moisture exposure, and have an increased chemical stability. The new pseudoplastic aqueous dispersions ought to be easy to repair on the basis of known pseudoplastic aqueous dispersions and ought to match or even exceed these known dispersions in terms of other performance properties.

The invention accordingly provides new pseudoplastic aqueous dispersions comprising solid and/or high-viscosity particles (A), dimensionally stable under storage and application conditions, in dispersion in a continuous aqueous phase (B), the dispersions comprising at least one solid polyurethanepolyol (C) containing cycloaliphatic structural units and having a glass transition temperature >15° C.

The new pseudoplastic aqueous dispersions are referred to below as “dispersions of the invention”.

In the light of the prior art it was surprising and unforeseeable for the skilled worker that the object on which the present invention was based could be achieved by means of the dispersions of the invention. A particular surprise was that the dispersions of the invention no longer had the disadvantages of the prior art but instead, following application, initial drying, and curing, especially thermal curing, gave coatings, adhesive layers, and seals, especially coatings, more particularly clearcoats, which were free from surface defects, in particular from pops, no longer showed any blushing after moisture exposure, and had an increased chemical stability. The dispersions of the invention were additionally easy to prepare on the basis of known pseudoplastic aqueous dispersions and match or even exceeded those dispersions in terms of their other performance properties.

The inventively essential constituent of the dispersions of the invention is at least one, especially one, polyurethanepolyol (C) which is solid, in particular at room temperature (23° C.), contains cycloaliphatic structural units, and has a glass transition temperature >15° C, preferably >30° C, and in particular >40° C.

The solid polyurethanepolyol (C) contains preferably at least two, more preferably at least three, very preferably at least four, and in particular at least five cycloaliphatic structural units.

The solid polyurethanepolyol (C) can contain more than two hydroxyl groups. Preferably it contains two hydroxyl groups, i.e., the solid polyurethanepolyol (C) is a diol. It can be branched, star-shaped, in comb form, or linear. Preferably it is linear. The hydroxyl groups are preferably terminal hydroxyl groups.

The cycloaliphatic structural units are preferably cycloalkanediyl radicals, having in particular 2 to 20 carbon atoms. The cycloalkanediyl radicals are preferably selected from the group consisting of cyclobutane-1,3-diyl, cyclopentane-1,3-diyl, cyclohexane-1,3- and -1,4-diyl, cycloheptane-1,4- diyl, norbornane-1,4-diyl, adamantane-1,5-diyl, decalindiyl, 3,3,5- trimethylcyclohexane-1,5-diyl, 1 -methylcyclohexane-2,6-diyl, dicyclohexylmethane4,4′-diyl, 1, l′-dicyclohexane4,4′-diyl, and 1,4- dicyclohexylhexane-4,4″-diyl, especially 3,3,5-trimethylcyclohexane-1,5- diyl or dicyclohexylmethane-4,4′-diyl.

The solid polyurethanepolyol (C) may include minor amounts of flexibilizing structural units which as part of three-dimensional networks lower their glass transition temperature T_{g}. “Minor amounts” means that the flexibilizing structural units are! present in an amount such that the glass transition temperature of the corresponding polyurethane (C) does not drop below 15° C, preferably riot below 30° C, and in particular not below 40° C. Examples of suitable flexibilizing structural units are known from German patent application DE 101 29 970 A 1, page 8, para. [0064] to page 9, para. [0072].

The solid polyurethanepolyol (C) is preferably substantially or entirely free from aromatic structural units. “Substantially free” means that the solid polyurethanepolyol (C) contains aromatic structural units in an amount that does not affect the performance properties and in particular does not adversely affect the UV stability of the polyurethanepolyol (C).

The solid polyurethanepolyol (C) is preferably hydrophobic, which is to say that in a liquid two-phase system composed of an apolar organic phase and an aqueous phase it tends to depart the aqueous phase and to collect predominantly in the organic phase. Preferably, therefore, the solid polyurethanepolyol (C) contains only a small number, if any, of pendant hydrophilic functional groups, such as (potentially) ionic groups or poly(oxyalkylene) groups.

The solid polyurethanepolyol (C) can be prepared by conventional processes of polyurethane chemistry. It is preferably prepared in organic solution form polyisocyanates, preferably diisocyanates, in particular cycloaliphatic diisocyanates, and polyols, preferably diols, in particular cycloaliphatic diols, in solution.

Use is made in particular of cycloaliphatic diisocyanates and/or cycloaliphatic diols which contain the cycloaliphatic structural units described above.

Examples of suitable cycloaliphatic diisocyanates are isophorone diiso- cyanate (i.e., 5-isocyanato-I -isocyanatomethyl-1,3,3-trimethylcyclo- hexane), 5-isocyanato-1 -(2-isocyanatoeth-1 -yl)-1,3,3- trimethylcyclohexane, 5-isocyanato-1 -(3-isocyanatoprop-1 -yl)-1,3,3- trimethylcyclohexane, 5-isocyanato-(4-isocyanatobut-1 -yl)-1,3,3- trimethylcyclohexane, 1 -isocyanatc-2-(3-isocyanatoprop-1 -yl)cyclohexane, 1-isocyanato-2-(3-isocyanatoeth-1-yl)cyclohexane, 1 -isocyanato-2-(4- isocyanatobut-1 -yl)cyclohexane, 1,2-diisocyanatocyclobutane, 1,3- diisocyanatocyclobutane, 2-diisocyanatocyclopentane, 1,3- diisocyanatocyclopentane, 1,2-diisocyanatocyclohexane, 1,3- diisocyanatocyclohexane, 1,4-diisocyanatocyclohexane or dicyclohexylmethane 2,4′-diisocyanate (H12-MDI), especially isophorone diisocyanate and H12-MDI.

Examples of suitable cycloaliphatic diols are cyclobutane-1,3-diol, cyclopentane-1,3-diol, cyclohexane-1,2-, -1,3-, and -1,4-diol, cycloheptane-1,4-diol, norbornane-1,4-diol, adamantane-1,5-diol, decalindiol, 3,3,5-trimethylcyclohexane-1,5-diol, 1-methylcyclohexane-2,6- diol, cyclohexanedimethanol, dicyclohexylmethane-4,4′-diol, 1,1′-dicyclohexane-4, 4′-diol, and 1,4-dicyclohexylhexane4,4″-diol, especially 5 3,3,5-trimethylcyclohexane-1,5-diol or dicyclohexylmethane4,4′-diol.

For preparing the solid polyurethanepolyol (C) it is additionally possible to employ aliphatic polyisocyanates, especially diisocyanates, and/or polyols, especially diols, which contain the flexibilizing structural units described above in minor amounts as defined above. They are described in, for example, German patent application DE 101 29 970 A 1, page 9, para. [0074] and para. [0098], which bridges pages 10 and 11.

The organic solution comprises preferably at least one inert organic solvent, preferably a low-boiling organic solvent, which under the conditions in which the solid polyurethane (C) is prepared reacts neither with the polyisocyanates nor with the polyols. Examples of suitable organic solvents are known from the book “Paints, Coatings and Solvents”, second, completely revised edition, edited by D. Stoye and W. Freitag, Wiley-VCH, Weinheim, New York, 1998.

The molar ratio of polyisocyanates, especially diisocyanates, to polyols, especially diols, may vary widely. It is important that the polyols are used in excess, so that hydroxyl-terminated polyurethanes (C) are formed. The molar ratio is preferably chosen such that the ratio of hydroxyl to isocyanate groups is from 1.1:1 to 2:1, in particular from 1.3:1 to 1.6:1.

The reaction of the polyisocyanates, especially diisocyanates, with the polyols, especially diols, is preferably conducted in the presence of conventional catalysts, especially tin catalysts such as dibutyltin dilaurate.

In the dispersions of the invention the solid polyurethanepolyol (C) is present in an amount, based in each case on a dispersion of the invention, of preferably from 1 to 50% by weight, more preferably from 5 to 40% by weight, and in particular from 10 to 30% by weight. The polyurethanepolyol can be present as a separate dispersed phase (C) alongside the dimensionally stable particles (A). Alternatively some of the solid polyurethanepolyol (C) is in the dimensionally stable particles (A) and the remainder is in the form of a separate dispersed phase (C). It is preferred for the entirety of the solid polyurethanepolyol (C) to be in the dimensionally stable particles (A).

The other key constituents of the dispersions of the invention are the solid and/or high-viscosity particles (A), dimensionally stable under storage and application conditions, such as are defined in German patent application DE 100 27 292 A 1, page 2, paras. [0013] to [0015].

In the dispersion of the invention these particles are present in an amount of preferably from 10 to 80%, more preferably from 15 to 75%, very preferably from 20 to 40%, and in particular from 30 to 65% by weight, based in each case on the dispersion of the invention. They preferably have the particle sizes described in German patent application DE 100 27 292 A 1, page 3, paras. [0017] and [0018] and also the solvent contents stated on page 3, para. [0019].

The physical composition of the particles (A) may vary very widely and is guided by the requirements of the case in hand. Examples of suitable physical compositions are known from German patent applications

DE 196 13 547 A 1, column 1 line 50 to column 3 line 52;

DE 198 41 842 A 1, page 3 line 45 to page 4 line 44;

DE 199 59 923 A 1, page 4 line 37 to page 10 line 34, and page 11 lines 10 to 36; and

DE 100 27 292 A 1, page 6, para. [056] to page 12, para. [0099].

The dimensionally stable particles (A) used with particular preference in accordance with the invention comprise, in addition to the conventional constituents described above, at least one, especially one, solid polyurethane (C) for inventive use, preferably in an amount such as to give the above-described amount of (C) in the dispersions of the invention.

Suitable continuous aqueous phases (B) are all those commonly used for preparing powder slurries. Examples of suitable aqueous phases (B) are described in German patent application DE 101 26 649 A 1, page 12, para. [0099] in conjunction with page 12, para. [0110], to page 16, para. [0146], or in German patent application DE 196 13 547 A 1, column 3 line 66 to column 4 line 45. In particular the aqueous phase (B) comprises the thickeners described in German patent application DE 198 41 842 A 1, page 4 line 45 to page 5 line 4, which allow the pseudoplastic behavior elucidated therein to be established in the dispersions of the invention. The aqueous phase (B) may further comprise at least one additive, as described in, for example, German patent application DE 100 27 292 A 1, page 11, para. [0097] to page 12, para. [0099].

In terms of method the preparation of the dispersions of the invention presents no peculiar features, but can instead take place by means of the conventional processes of the prior art. In such processes the dimensionally stable particles (A) described above are dispersed in a continuous aqueous phase (B), the solid polyurethanepolyol (C) preferably being mixed with the remaining constituent(s) of the dimensionally stable particles (A) and the resultant mixture being dispersed in the aqueous phase (B).

Dispersions of the invention can for example be prepared by first preparing a powder coating material (A) from the constituents of the dimensionally stable particles (A), by extrusion and grinding, and then wet- milling said coating material (A) in water or in an aqueous phase (B), as described in, for example, German patent applications DE 196 13 547 A 1, DE 196 18 657 A 1, DE 198 14 471 A 1 or DE 199 20 141 A 1.

Dispersions of the invention can also be prepared by what is called the secondary dispersion process, in which case the constituents of the particles (A) plus water are emulsified in an organic solvent to give an oil- in-water emulsion and then the organic solvent is removed from said emulsion, causing the emulsified droplets to solidify, as is described in, for example, German patent applications DE 198 41 842 A 1, DE 100 01 442 A 1, DE 100 55 464 A 1, DE 101 35 997 A 1, DE 101 35 998 A 1 or DE 10135999A1.

The dispersions of the invention may additionally be prepared by what is called the primary dispersion process, in which olefinically unsaturated monomers are polymerized in an emulsion, as described in, for example, German patent application DE 199 59 923 A 1. In accordance with the invention, in addition to the constituents described therein, the emulsion includes at least one of the above-described polyurethanepolyols (C).

The dispersions of the invention may be prepared, moreover, by means of what is called the melt emulsification process, in which a melt of the constituents of the particles (A) is introduced into an emulsifier apparatus, preferably with the addition of water and stabilizers, and the resultant emulsion is cooled and filtered, as is described in, for example, German patent applications DE 100 06 673 A 1, DE 101 26 649 A 1, DE 101 26 651 A 1 or DE 101 26 652 A 1.

The dispersions of the invention are prepared in particular by the secondary dispersion process.

The dispersions of the invention are outstandingly suitable as coating materials, adhesives, and sealants. They are outstandingly suitable for coating, adhesively bonding, and sealing bodies of means of transport and parts thereof, buildings and parts thereof, doors, windows, furniture, small industrial parts, mechanical, optical, and electronic components, coils, containers, packaging, hollow glassware, and articles of everyday use.

They are preferably employed as coating materials, more preferably as powder slurry clearcoat materials. In particular they are suitable for producing clearcoats as part of multicoat color and/or effect paint systems, especially by the wet-on-wet technique, as is described in, for example, German patent application DE 100 27 292 A 1, page 13, para. [0109] to page 14, para. [0118].

Like conventional powder slurries, the dispersions of the invention too can be applied to the substrates in question by means of conventional spray application techniques, as is described in, for example, German patent application DE 100 27 292 A 1, page 14, paras. [0121] to [0126].

The cure techniques employed in each case are guided by the physical composition of the dispersions of the invention and can be conducted, for example, as described in German patent application DE 100 27 292 A 1, page 14, para. [0128] to page 15, para. [0136].

In all applications the applied dispersions of the invention cure to give coatings, adhesive layers, and seals which even in high film thicknesses exhibit no surface defects, in particular no pots, no blushing after moisture exposure, and which have an outstanding chemical stability. In addition it is possible to overcoat the coatings, adhesive layers, and seals entirely without problems, this being particularly important for the purpose, for example, of automotive refinish.

### EXAMPLES

### Preparation Example 1

The Preparation of a Solution Polyacrylate Resin

442.84 parts of methyl ethyl ketone (MEK) were charged to a reaction vessel and heated to 80° C. Metered in to this initial charge over the course of 4 h at 80° C from two separate feed vessels were the initiator, consisting of 47.6 parts of TBPEH (tert-butyl perethylhexanoate) and 33.5 parts of MEK, and the monomer mixture, consisting of 183.26 parts of tert-butyl acrylate, 71.4 parts of n-butyl methacrylate, 95.2 parts of cyclohexyl methacrylate, 121.38 parts of hydroxyethyl methacrylate, and 4.76 parts of acrylic acid. The reaction mixture was held at 80° C for a further 1.5 h. Thereafter a fraction of the volatile components was stripped in the vacuum from the reaction mixture under 500 mbar over 5 h, until the solids content was 70% by weight. The resin solution was thereafter cooled to 50° C and discharged.

The characteristics of the resin solution were as follows:

Solids: 70.2% (1 h at 1:30° C)

Viscosity: 4.8 dpas (cone and plate viscometer at 23° C; 55% strength solution, diluted with xylene)

Acid number: 43.4 mg KOH/g resin solids

### Preparation of Example 2

The Preparation of a Blocked Cycloaliphatic Polyisocyanate as Crosslinking Agent

837 parts of isophorone diisocyanate were charged to a suitable reaction vessel and 0.1 part of dibutyltin dilaurate was added. A solution of 168 parts of trimethylolpropane and 431 parts of methyl ethyl ketone was then run in slowly. The exothermic reaction raised the temperature. After 80° C had been reached the temperature was kept constant by external cooling and the feed rate was reduced slightly where appropriate. After the end of the feed the batch was maintained at this temperature for about 1 hour until the isocyanate content of the solids had reached 15.7% (based on NCO groups). The reaction mixture was subsequently cooled to 40° C and a solution of 362 parts of 3,5-dimethylpyrazole in 155 parts of methyl ethyl ketone was added over the course of 30 minutes. After the reaction mixture had heated up to 80° C as a result of the exothermic reaction, the temperature was maintained constant for 30 minutes until the NCO content had dropped to less than 0.1%. At that point 47 parts of n-butanol were added to the reaction mixture, which was held at 80° C for a further 30 minutes and then, after brief cooling, discharged.

The solids content of the reaction product was 69.3% (1 h at 130° C).

### Preparation Example 3

The Preparation of a Blocked Aliphatic Polyisocyanate as Crosslinking Agent

534 parts of Desmodur® N 3300 (commercial trimer of hexamethylene diisocyanate from Bayer AG) and 200 parts of MEK were introduced as an initial charge and heated to 40° C. Subsequently, with cooling, 100 parts of 3,5-dimethylpyrazole were added, after which an exothermic reaction began. After the exothermic heat had subsided a further 100 parts of 3,5- dimethylpyrazole were added, again with cooling. After the renewed exothermic heat had subsided a further 66 parts of 3,5-dimethylpyrazole were added. Cooling was then slowly brought to a stop, whereupon the reaction mixture heated up slowly to 80° C. The reaction mixture was held at this temperature until its isocyanate content had dropped to <0.1%. Subsequently the reaction product was cooled and discharged.

The blocked polyisocyanate had a solids content of 80% by weight (1 h at 130° C) and a viscosity of 3.4 dPas (70% in MEK; comb and plate viscometer at 23° C).

### Preparation Examples 4 to 9

The Preparation of Polyurethanediols (C 1) to (C 6)

Polyurethanediols (C 1) (Preparation Example 4) to (C 6) (Preparation Example 9) were prepared in accordance with the following general procedure:

Dicyclohexylmethane diisocyanate and at least one diol were dissolved in methyl ethyl ketone under inert gas in the desired molar ratio, so as to give a solution of a solids content of from 65 to 70% by weight. Dibutyltin dilaurate was added in an amount of 0.07% by weight, based on solids. The reaction mixture was heated under reflux with stirring until the free isocyanate group content had dropped below the detection limit. Table 1 gives an overview of the starting products used and their amounts.

For determination of the glass transition temperatures the solid polyurethanepolyols (C 1) to (C 6) were isolated. The glass transition temperatures were determined by differential thermal analysis (DSC). They too are given in Table 1.

TABLE 1
Die Herstellung der Polyurethanpolyole (C 1) bis (C
6) und ihre Glasübergangstemperaturen

| | Molverhältnisse | | | | | |
|---|---|---|---|---|---|---|
| | Herstellbeispiel/Polyurethanpolyol (C): | | | | | |
| Ausgangsprodukt | 4/C 1 | 5/C 2 | 6/C 3 | 7/C 4 | 8/C 5 | 9/C 6 |
| H12-MDI | 3 | 3 | 3 | 3 | 3 | 2 |
| DEOD | 4 | 3 | 2 | 1 | — | — |
| CHDM | — | 1 | 2 | 3 | — | 3 |
| 12-HSA | — | — | — | — | 4 | — |
| Glasübergangs- | 48 | 49 | 65 | 72 | 19 | 62 |
| temperatur (° C.) | | | | | | |

H12-MDI Dicyclohexylmethandiisocyanat;
DEOD Diethyloctan-1,5-diol;
CHDM Cyclohexyldimethanol;
12-HSA 12-Hydroxystearylalkohol

### Examples 1 to 6 (Inventive) and V 1 (Comparative)

The Preparation of Powder Clearcoat Materials

Example V 1:

Example V 1 (comparative) was conducted as described in German patent application DE 100 40 223 A 1, Example 1, page 8, para. [0103] to page 9, para. [0104]:

321.4 parts of the binder solution from Preparation Example 1, 57.9 parts of the crosslinking agent solution from Preparation Example 2 (based on isophorone diisocyanate), and 120.7 parts of the crosslinking agent solution from Preparation Example 3 (based on hexamethylene diisocyanate) were mixed at room temperature in an open stirred vessel with stirring for 15 minutes. Then 7.2 parts of Cyagard® 1164 (UV absorber from Cytec), 2.2 parts of Tinuvin® flüssig 123 (liquid sterically hindered amine “HALS” from Ciba Geigy), 3 parts of N,N-dimethylethanolamine, 1.8 parts of benzoin, and 0.6 part of dibutyltin dilaurate were added and the mixture was stirred at room temperature for a further 2 h. It was then diluted with 225.7 parts of deionized water in small portions. After a 15-minute wait a further 260 parts of deionized water were added. An emulsion was formed with a theoretical solids content of 37%.

The emulsion was diluted with 283 parts of deionized water and an equal amount of a mixture of volatile organic solvents and water was stripped off on a rotary evaporator under reduced pressure until the solids content was again at 37% by weight (1 h at 130° C), giving a slurry.

The desired viscosity behavior was set by adding 22.6 parts of Acrysol® RM-8W (commercial thickener from Rohm & Haas) and 6.5 parts of Viscalex® HV 30 (commercially thickener from Allied Colloids) to 1000 parts of the slurry. The resulting powder clearcoat slurry had the following characteristics:

| | |
|---|---|
| Festkörper (1 h bei 130° C.): | 36.6% |
| Partikelgröβe: | 6.4 μm (D.50; Laserbeugungsmessgerät |
| | der Firma Malvern) |

Viskositätsverhalten:
1.920 mPas bei einer Scherrate von 10 s⁻¹
760 mPas bei einer Scherrate von 100 s⁻¹
230 mPas bei einer Scherrate von 1000 s⁻¹

Examples 1 to 6 (Inventive):

For Examples 1 to 6 Example V 1 was repeated with a difference that in each examples 94.3 parts by weight, corresponding to 20% by weight, based on solids, of in each case one of the polyurethanepolyols (C) were added. The specific polyurethanepolyols (C) added were:

for Example 1, (C 1) from Preparation Example 4,

for Example 2, (C 2) from Preparation Example 5,

for Example 3, (C 3) from Preparation Example 6,

for Example 4, (C 4) from Preparation Example 7,

for Example 5, (C 5) from Preparation Example 8, and

for Example 6, (C 6) from Preparation Example 9.

Amounts of water and thickeners were added in each case so as to give the same solids content, particle size, and viscosities as for the powder slurry clearcoat material of Example V 1.

The powder slurry clearcoat materials of Examples 1 to 6 and V 1 were stable on storage; any small amounts of sediment produced were very easily reagitated. They were also readily processible by spray application and dried on the substrates without filming.

### Examples 7 to 12 (Inventive) and V 2 (Comparative)

The Production of Clearcoats from the Powder Slurry Clearcoat Materials of Examples 1 to 6 and V 1

For the application of the powder slurry clearcoat materials an integrated system was prepared. This was done by applying first a functional coat (Ecoprime® Meteorgrau [meteor grey]; BASF Coatings AG) using a cup-type gun to steel panels which had been cathodically coated with commercial electrocoat material. After a 5-minute flashoff at room temperature the functional coat was overcoated in the same way with a black aqueous basecoat material from BASF Coatings AG, after which the two films were subjected to initial drying at 80° C for 5 minutes. After the panels had cooled, the powder slurry clearcoat materials were applied in the same way. The panels were subsequently first flashed off for 5 minutes and then subjected to initial drying at 40° C for 15 minutes. The powder slurry clearcoat films dried as powder and did not film. They were then baked at 145° C for 30 minutes.

The clearcoat materials used for each example were as follows:

for Example 7, the powder slurry clearcoat material from Example 1;

for Example 8, the powder slurry clearcoat material from Example 2;

for Example 9, the powder slurry clearcoat material from Example 3;

for Example 10, the powder slurry clearcoat material from Example 4;

for Example 11, the powder slurry clearcoat material from Example 5;

for Example 12, the powder slurry clearcoat material from Example 6; and

for Example V 2, the powder slurry clearcoat material from Example V 1.

This gave multicoat paint systems in a black color. The wet films applied were selected such that the dry film thicknesses after baking were 15 μm each for the functional coat and for the basecoat. The clearcoats had a film thickness of 44 to 48 μm.

Table 2 gives an overview of the tests conducted and the results obtained therein.

TABLE 2
Die anwendungstechnischen Eigenschaften der Klarlackierungen
der Beispiele 7 bis 12 und des Vergleichsversuchs V 2

| | Beispiele: | | | | | | Vergl. |
|---|---|---|---|---|---|---|---|
| Eigenschaften | 7 | 8 | 9 | 10 | 11 | 12 | V1 |
| Glanz (20°) ^{a}) | 85 | 85 | 84 | 85 | 85 | 83 | 84 |
| Visuelle Beurtei- | | | | | | | |
| lung: | | | | | | | |
| Aussehen ^{b}) | br. | br. | gl. | br | gl. | br. | gl. |
| Verlauf (Note) ^{c}) | 1 | 2 | 1 | 1 | 2 | 1 | 2 |
| Kocher ^{d}) | k. | k. | k. | k. | k. | k. | k. |
| Mudcracking ^{e}) | k. | k. | k. | k. | k. | k. | k. |
| Weiβanlaufen im | k. | k. | k. | k. | k. | k. | k. |
| Heiβwassertest ^{e}) | | | | | | | |
| Chemikalien- | | | | | | | |
| Beständigkeit ^{f}) | | | | | | | |
| H₂SO₄ 1%-ig | 55 | 54 | 56 | 55 | 54 | 56 | 50 |
| Pankreatin | 57 | 58 | 57 | 59 | 58 | 58 | 54 |
| Baumharz | 48 | 48 | 47 | 48 | 48 | 48 | 43 |
| Wasser | >70 | >70 | >70 | >70 | >70 | >70 | 60 |

^{a}) MeBgerät, Hersteller Fa. Byk;
^{b}) b. = brillant; gl. = glänzend;
^{c}) Note 1 = sehr gut; Note 2 = gut;
^{d}) k. = keine;
^{e}) k. = kein;
^{f}) Messung mittels Gradientenofen, Hersteller Fa. Byk. Der Zahlenwert gibt die untere Temperatur an, ab der auf der Klarlackierung aufgetragene Tropfen der entsprechenden Substanz sichtbare Spuren hinterlassen;

The results compiled in the table underline the fact that, starting from an already very high level, the chemical resistance of the prior art clearcoats could be increased further without detriment to the overall appearance or to the blush resistance.

1. A pseudoplastic aqueous dispersion comprising solid and/or high-viscosity particles (A) that are, dimensionally stable under storage and application conditions, in dispersion in a continuous aqueous phase (B), wherein the dispersion comprises at least one solid polyurethanepolyol (C) containing cycloaliphatic structural units and having a glass transition temperature>15° C.

2. The pseudoplastic aqueous dispersion of claim 1, wherein the soid polyurethanepolyol (C) has a glass transition temperature>30° C.

3. The pseudoplastic aqueous dispersion of claim 1, wherein the solid polyurethanepolyol (C) is a diol.

4. The pseudoplastic aqueous dispersion of claim 1, wherein the solid polyurethanepolyol (C) is linear.

5. The pseudoplastic aqueous dispersion of claim 1, wherein the cycloaliphatic structural units are cycloalkanediyl radicals having 2 to 20 carbon atoms.

6. The pseudoplastic aqueous dispersion of claim 5, wherein the cycloalkanediyl radicals are selected from the group consisting of cycloheptane-1,3-diyl , cyclopentane-1,3-diyl, cyclohexane-1,3-and-1,1diyl, cycloheptane-1,4-diyl, norbornane-1,4-diyl, adamantane-1,5-diyl, decalindiyl, 3,3,5-trimethylcyclohexane-1,5-diyl, 1-methylcyclohexane-2,6-diyl, dicyclohexylmethane-4,4′-diyl, 1,1′-dicyclohexane-4, 4′-diyl, and 1,4-dicyclohexylhexane-4,4′-diyl, especially 3,3,5-trimethylcyclohexane-1, 5-diyl or dicyclohexylmethane-4,4′-diyl.

7. The pseudoplastic aqueous dispersion of claim 1, wherein the solid polyurethanepolyol (C) is substantially from aromatic stuctural units.

8. The pseudoplastic aqueous dispersion of claim 1, comrising the solid polyurethanepolyol (C) based on the solids of the dispersion, in an amount of from 1 to 50% by weight.

9. The pseudoplastic aqueous dispersion of claim 1, wherein the solid polyurethanepolyol (C) is in the dimensionally stable particles (A).

10. (canceled)

11. A method of applying comprising applying pseudoplastic aqueous dispersion of claims 1 to a substrate, wherein the pseudoplastic aqueous dispersion is at least one of a coating material, an adhesive or a sealant.

12. The method of claim 11, wherein the substrate is at least one of bodies of means of transport and parts thereof, buildings and parts thereof, doors, windows, furniture, small industrial parts, mechanical, optical, and electronic components, coils, containers, packaging, hollow glassware or articles of everyday use.

13. A process for preparing a pseudoplastic aqueous dispersion comprising:
incorporating at least one solid polyurethanepolyol (C) into solid and/or high viscosity particles (A); and
dispersing solid and/or high viscosity particles (A) in a continuous aqueous phase (B), wherein the at least one polyurethanepolyol (C) contains cycloaliphatic structural units and has a glass transition temperature>15° C.
